(19) United States
(12) Patent Application Publication
(10) Pub. No.: US 2005/0212877 A1
(43) Pub. Date: Sep. 29, 2005

(54) Separable ink cartridge

(76) Inventor: Sheng-Chiao Liang, Kaohsiung City (TW)

Correspondence Address: DAVID E. DOUGHERTY;Dennison, Schultz, Dougherty & Macdonald, Suite 105, 1727 King Street, Alexandria, VA, 22314-2700, US

(21) Appl. No.: 10/806,383

(22) Filed: Mar. 23, 2004

(51) Int. Cl. B41J 2/175

(52) U.S. Cl. 347/86

(57) ABSTRACT

This is a separable ink cartridge which was conceived by reforming the design of single-piece cartridges into an ink cartridge with two separate parts: an internal compartment and an external carapace. The internal compartment is outfitted with an inkwell, spray nozzle, and air vent, while the external carapace has an identification chip and printer connection clasps. When combined, the internal compartment and external carapace form a complete ink cartridge that can be inserted and used in a printer. After the ink cartridge is empty, the internal compartment and external carapace can be separated, the empty internal compartment disposed of, and the external carapace reused with a new internal compartment. This design allows a reduction of materials and cost, and is good for environmental protection.

### BACKGROUND OF THE INVENTION

The invention relates to an ink cartridge, and is more particularly to separation of its interior and exterior for disposing interior compartment after use.

This invention is a separable ink cartridge that is notable for the structure of its interior and exterior, which allows the cartridge to be separated, and the interior compartment disposed of after use. The remaining outer carapace, which is outfitted with an identification chip, allows a new interior compartment to be inserted, and reused, thus reducing materials, cost, and environmental harm.

Generally, ink cartridges are basically composed of an ink and a carapace. The most commonly used ink cartridge on the current market is composed of only one piece, i.e. there are many basic structures located on the same unit, including an ink well, spray nozzle, air vent (to balance pressure within the ink well), identification chip (to identify the cartridge), and an attachment clasp on the exterior (to connect the cartridge to a printer). With the exception of the identification chip and spray nozzle, the above pieces are made almost entirely out of plastic, yet the entire unit is disposed of and replaced after use. In actuality, there are many portions of ink cartridges that can be reused, especially the identification chip that is attached to all types of cartridges. From this, we can see that a great deal of materials are wasted each time the ink cartridge is disposed of. This can cause an increase of waste, environmental damage, and cost (the identification chip is particularly expensive), thus negatively affecting the product's competitivity.

Based on the foregoing, it is the general object of the present invention to overcome and drawbacks of prior art ink cartridge.

### SUMMARY OF THE INVENTION

In one aspect, the present invention is directed to a ink cartridge can be separated, and transform the single-piece models into separable ink cartridges composed of an inner compartment and external carapace.

In one embodiment, the interior compartment of the new design still includes the necessary ink cartridge components that were present in original models, such as ink wells, spray nozzles, and air vents, while the outer carapace is outfitted with the identification chip and printer connection clasps. The two pieces can then simply combine to form an ink cartridge, which can be installed into a printer. After the ink cartridge is empty, the interior compartment can be easily removed and discarded, while the exterior carapace is saved and reused, with the aid of a new internal compartment.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is an elevation view of the present invention;

FIG. 2 is an exploded perspective view of FIG. 1; and

FIG. 3 is a side view of the interior compartment of FIG. 2.

### DETAILED DESCRIPTION OF THE PREFERRED EMBODIMENTS

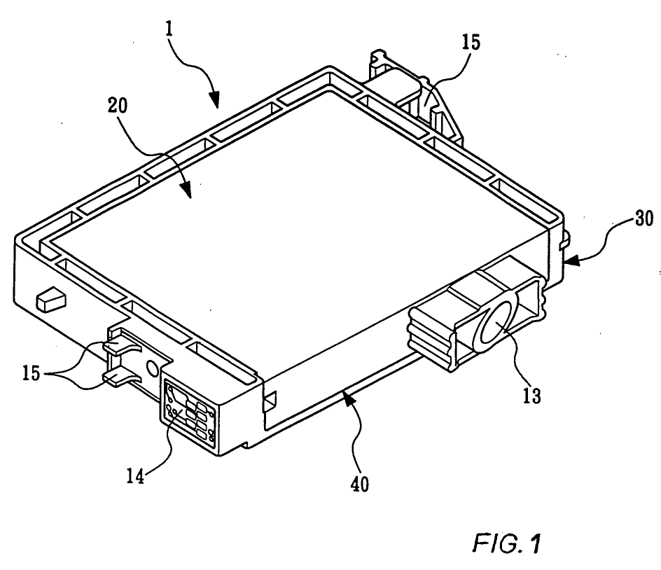

As shown in FIGS. 1, 2, and 3, a separable ink cartridge 1 comprises several conventional basic components, including:

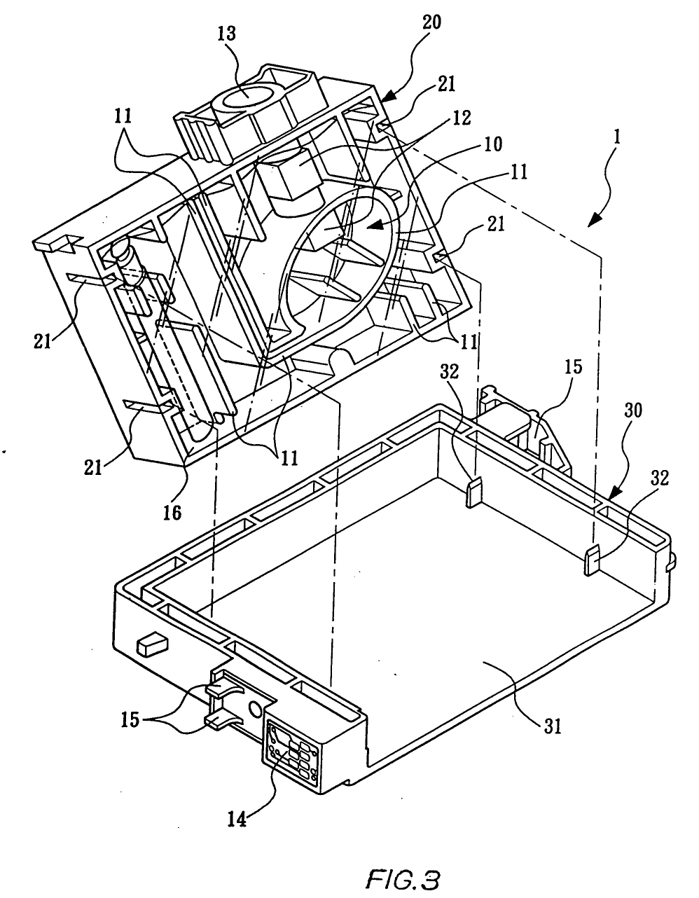

an inkwell 10 which is used to store the ink. Inside the inkwell 10, it includes different shaped dividers 11 and ink tube 12, as shown in FIG. 3, and the ink tube 12 is usually connected with filters (not shown in the drawings);

a spray nozzle 13 to release the ink, and an air vent (not shown in the drawings) to balance inkwell pressure when opened. The air vent is generally covered with a piece of affixed paper that must be removed before use for ventilation.. This strip of paper also serves as easy identification whether or not the cartridge has been previously used;

in addition, there is an identification chip 14 for identification of the cartridge (such as name brand or off brand). The printer connection clasps 15 on the external carapace allow the ink cartridge to be affixed to the clasps on the inside of a printer. Aside from the identification chip 14 and spray nozzle 13, all of the components listed above are made from plastic.

In the illustrated embodiment, the single-piece ink cartridge 1 can be separated into two separate pieces including an interior compartment 20 and external carapace 30. On the internal compartment, there is an inkwell 10, spray nozzle 13, and air vents, as prior art. In addition, a plastic strip 16 can be used on the internal compartment to seal the open outer side of the ink well 10, as shown in FIG. 3. The plastic external carapace is then used to replace this side, and forms a sealed compartment when attached to the ink well 10. The plastic strip 16 is thin enough such that it will not affect the connectivity between the inner compartment 20 and external carapace 30. The interior space 31 of the “unshaped” external carapace 30 allows the internal compartment 20 to be inserted, thus assembling the two parts into a fully assembled, standard sized ink cartridge 1. The external carapace is outfitted with an identification chip 14 and printer connection clasps 15, as found on prior art.

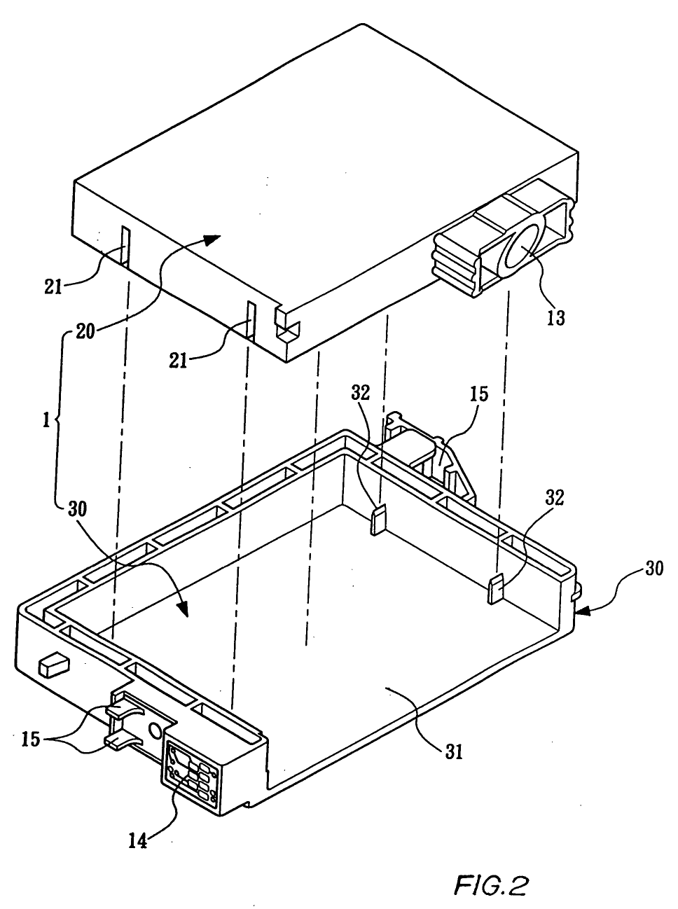

Perferably, the internal connection clasps 21 & 32 on the internal compartment and external carapace allow the connection of the two pieces. Connective clasp 21 has a concave shape that can easily connect with the convex shape of connective clasp 32, as shown in FIGS. 2 and 3, thus forming the single ink cartridge unit. The plastic strip 16 covering the connective clasp 21 automatically breaks away when the two pieces are combined. One can then apply pressure to the connective boundary line 40 between the internal compartment 20 and external carapace 30 to easily separate the two pieces.

Moreover, when in use, the internal compartment 20 and external carapace 30 are combined to form a complete, standard size ink cartridge 1, allowing it to be installed in a printer as with prior art. After the cartridge is empty, remove and dispose the empty internal compartment 20; save the external carapace 30 (with identification chip 14 and printer connection clasps 15), combine it with a new internal compartment, and reuse. The present invention conserves materials because the external carapace can be reused; it lowers cost and increases product competitivity because the identification chip 14 is connected to this external carapace; it benefits the environment due to the fact that it eliminates the waste of the external carapace. While preferred embodiments have been shown and described, various modifications and substitutions may be made without departing form the spirit and scope of the invention. Accordingly, it is to be understood that the present invention has been described by way of example, and not by limitation.

1. A separable ink cartridge comprising:
an internal compartment;
an external carapace;
said internal compartment being outfitted with an inkwell, spray nozzle, and air vent; and
said internal compartment and said external carapace being connected by connecting clasps.

2. The separable ink cartridge of claim 1, wherein said ink well being covered using a plastic strip.

3. The separable ink cartridge of claim 1, wherein said external carapace is u-shaped.

4. The separable ink cartridge of claim 1, wherein said interior of which allows the insertion of said internal compartment, forming said complete, standard size ink cartridge.

5. The separable ink cartridge of claim 3, wherein said external carapace has an identification chip and printer connection clasps.

6. The separable ink cartridge of claim 1, wherein said internal compartment and said external carapace to be connected as said complete ink cartridge for use in printers.

7. The separable ink cartridge of claim 1, wherein said cartridge is empty, then said internal compartment and said external carapace can be separated.

8. The separable ink cartridge of claim 7, wherein said empty internal compartment disposed of, and said external carapace reused with a new internal compartment.
